(19) United States
(12) Patent Application Publication
(10) Pub. No.: US 2014/0125777 A1
(43) Pub. Date: May 8, 2014

(54) STEREOSCOPIC DISPLAY DEVICE

(71) Applicant: CHUNGHWA PICTURE TUBES, LTD., Taoyuan (TW)

(72) Inventors: Lun-Wei Kang, Taoyuan County (TW); Sung-Ching Jao, Taoyuan County (TW)

(73) Assignee: CHUNGHWA PICTURE TUBES, LTD., Taoyuan (TW)

(21) Appl. No.: 13/847,490

(22) Filed: Mar. 20, 2013

(30) Foreign Application Priority Data
Nov. 8, 2012 (TW) 101141609

(51) Int. Cl. H04N 13/04

(52) U.S. Cl. CPC H04N 13/0429
USPC 348/51

(57) ABSTRACT

A stereoscopic display device includes a display unit and a lens unit. The display unit has a display center axis corresponding to an interface between a first sub-pixel region and a second sub-pixel region of the stereoscopic display device. The display unit includes a first sub-pixel, a second sub-pixel, and a black matrix. The first sub-pixel is disposed in the first sub-pixel display region. The second sub-pixel is disposed in the second sub-pixel region. The black matrix is at least partially disposed between the first sub-pixel and the second sub-pixel. The lens unit is disposed correspondingly to the display unit. The lens unit includes a first sub-lens and a second sub-lens respectively disposed in the first sub-pixel region and the second sub-pixel region. The first sub-lens and the second sub-lens respectively have a first lens center axis and a second lens center axis deviating from the display center axis.

### BACKGROUND OF THE INVENTION

1. Field of the Invention

The present invention relates to a stereoscopic display device, and more particularly, to a stereoscopic display device wherein sub-lenses are disposed correspondingly to sub-pixels, and lens center axis of the sub-lenses deviate from a display center axis of a display unit.

2. Description of the Prior Art

The principle of the stereoscopic display technology includes delivering different images respectively to a left eye and a right eye of a viewer, to give to the viewer a feeling of gradation and depth in the images, thereby generating the stereoscopic effect in the cerebrum of the viewer by analyzing and overlapping the images received separately by the left eye and the right eye.

In general, the stereoscopic display technologies could be substantially divided into two major types, which are the glasses type and the naked-eye type (auto stereoscopic type). The parallax barrier type stereoscopic display technology and the lenticular lens type technology are most popular in the naked-eye type stereoscopic display technologies. In those technologies, barrier patterns or lens units are disposed in front of a general display panel, and different display images generated by adjacent pixels of the display panel may be guided toward the left eye or the right eye of the viewer through the barrier patterns or the lens units so as to generate the stereoscopic display effect.

Please refer to FIG. 1 and FIG. 2. FIG. 1 is a schematic diagram illustrating a display effect of a conventional lenticular lens type stereoscopic display device. FIG. 2 is a schematic diagram illustrating a display effect of another conventional lenticular lens type stereoscopic display device. In FIG. 1 and FIG. 2, the X-axis represents viewing angle, and the Y-axis represents luminance. Regions LR represent luminance conditions of left-eye display images in different viewing angles, and regions RS represent luminance conditions of right-eye display images in different viewing angles. In the conventional lenticular lens type stereoscopic display device, one lens is disposed correspondingly to two sub-pixels which provide the left-eye display image and the right-eye display image respectively. A black matrix is generally disposed between two adjacent sub-pixels. When the focal point of the lens is designed to be located on the sub-pixel, the left-eye display images and the right-eye display images will not be received by any eye within some view angle ranges and the blind spot problem may be generated as shown in FIG. 1. The view angles of the viewer may be accordingly limited and the stereoscopic display quality may also be influenced. Therefore, in some improving approaches, the focal point of the lens is designed to be not located on the sub-pixel so as to generate a defocus effect as shown in FIG. 2. In this way, the blind spot problem may be improved but the luminance variation may become larger within some viewing angle regions, and the display quality may become unstable within the viewing angle regions. Additionally, problems such as interference between the left-eye display image and the right-eye display image may be easily generated without carefully controlling the defocus related design.

### SUMMARY OF THE INVENTION

It is one of the objectives of the present invention to provide a stereoscopic display device. Sub-lenses are disposed correspondingly to sub-pixels, and lens center axes of the sub-lenses are designed to deviate from a display center axis of a display unit so as to improve the stereoscopic display blind spot issue in some specific viewing angles caused by black matrix.

To achieve the purposes described above, a preferred embodiment of the present invention provides a stereoscopic display device. The stereoscopic display device has a first sub-pixel region and a second sub-pixel region aligned along a first direction. The stereoscopic display device comprises a display unit and a lens unit. The display unit has a display center axis corresponding to an interface between the first sub-pixel region and the second sub-pixel region. The display unit comprises a first sub-pixel, a second sub-pixel, and a black matrix. The first sub-pixel is disposed in the first sub-pixel region, and the second sub-pixel is disposed in the second sub-pixel region. The black matrix is at least partially disposed between the first sub-pixel and the second sub-pixel. The lens unit is disposed correspondingly to the display unit. The lens unit comprises a first sub-lens and a second sub-lens. The first sub-lens is disposed in the first sub-pixel region. The first sub-lens has a first lens center axis. The second sub-lens is disposed in the second sub-pixel region. The second sub-lens has a second lens center axis. The first lens center axis and the second lens center axis deviate from the display center axis along the first direction.

### BRIEF DESCRIPTION OF THE DRAWINGS

FIG. 1 is a schematic diagram illustrating a display effect of a conventional lenticular lens type stereoscopic display device.

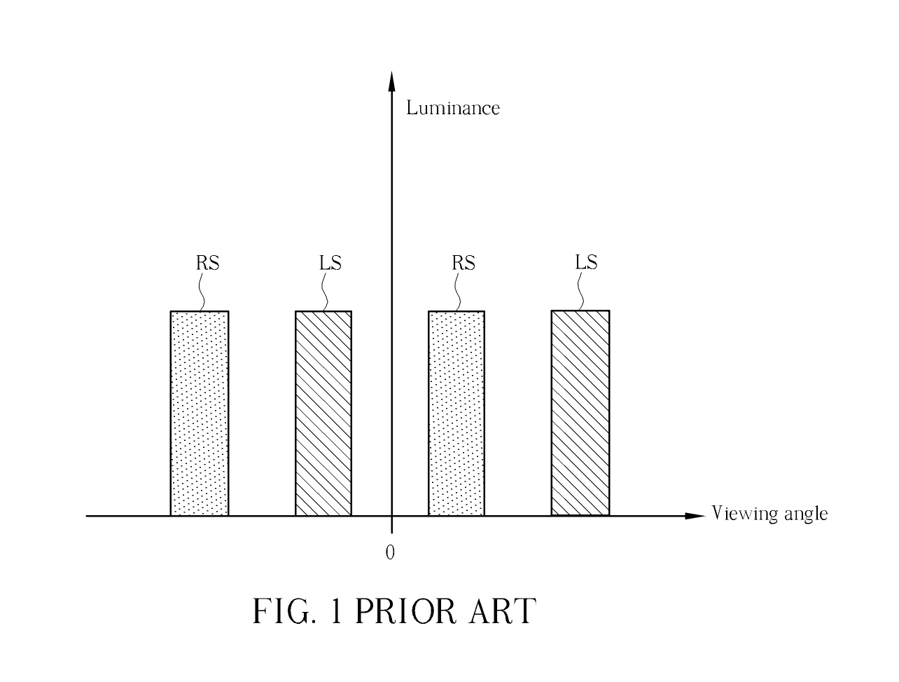

FIG. 2 is a schematic diagram illustrating a display effect of another conventional lenticular lens type stereoscopic display device.

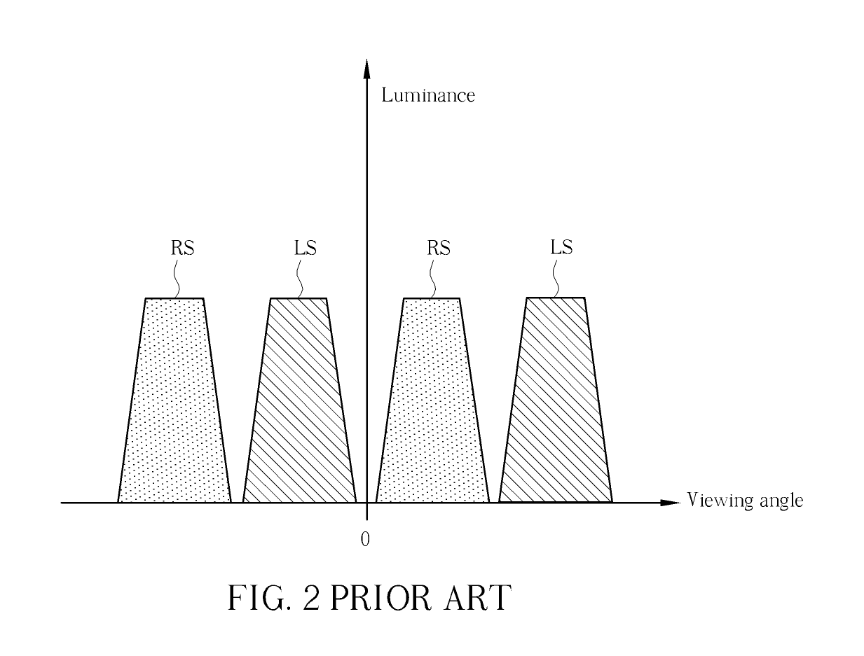

FIG. 3 is a schematic diagram illustrating a stereoscopic display device according to a preferred embodiment of the present invention.

FIG. 4 is a schematic diagram illustrating a display effect of the stereoscopic display device according to a preferred embodiment of the present invention.

FIG. 5 is a schematic diagram illustrating a stereoscopic display device according to another preferred embodiment of the present invention.

### DETAILED DESCRIPTION

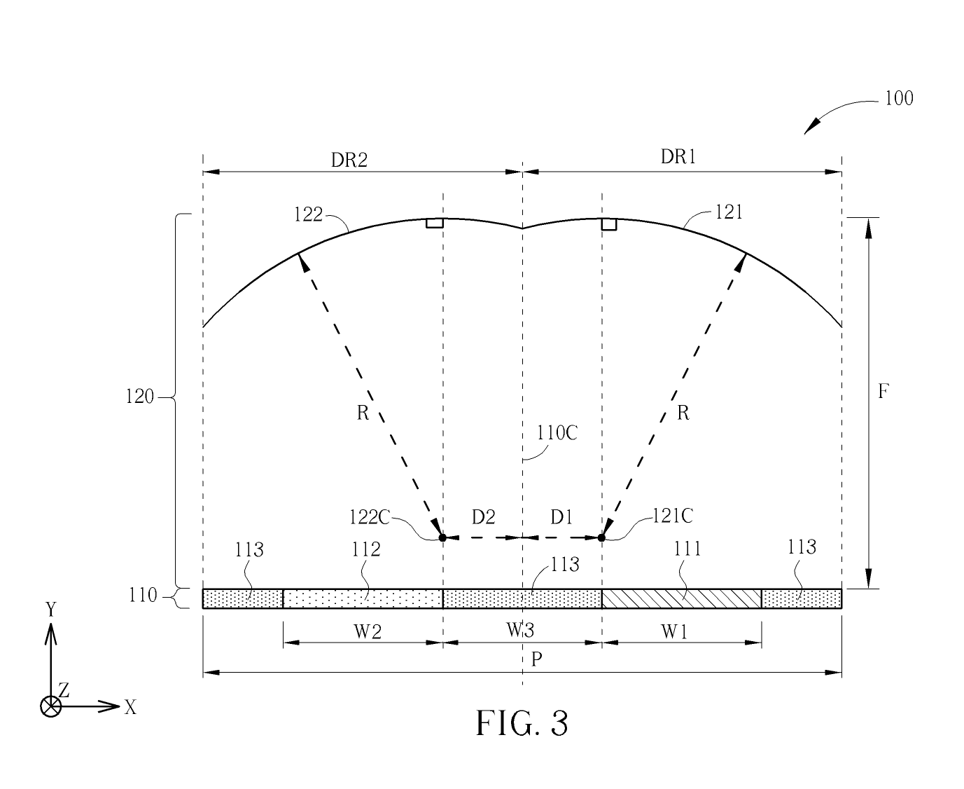

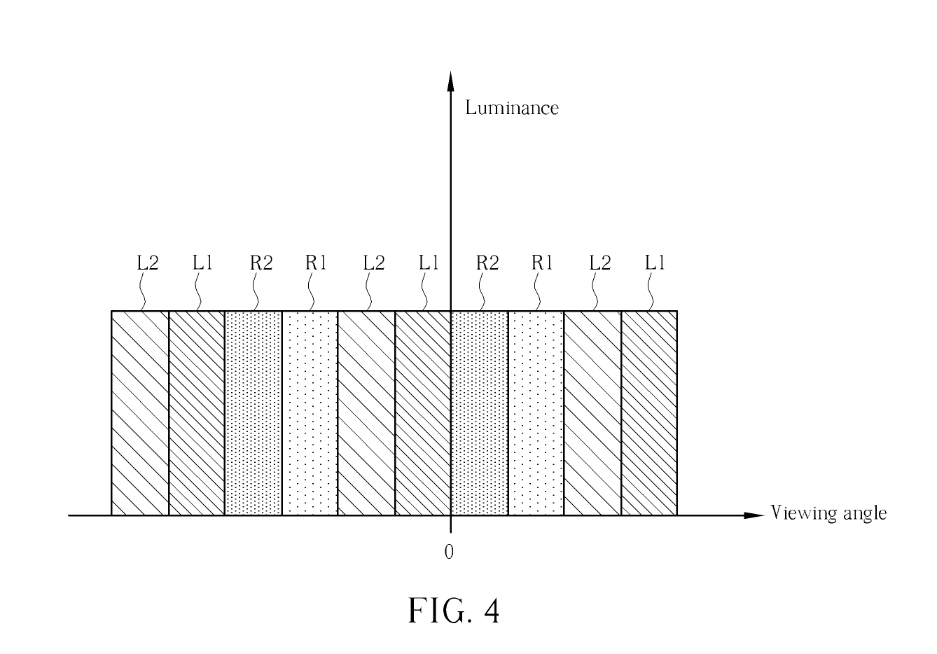

Please refer to FIG. 3 and FIG. 4. As shown in FIG. 3, a stereoscopic display device 100 is provided in this embodiment. The stereoscopic display device 100 has a first sub-pixel region DR1 and a second sub-pixel region DR2 aligned along a first direction X. The stereoscopic display device 100 includes a display unit 110 and a lens unit 120. The display unit 110 has a display center axis 110C extending along a second direction Y perpendicular to the display unit 110. The display center axis 110C corresponds to an interface between the first sub-pixel region DR1 and the second sub-pixel region DR2. The display unit 110 includes a first sub-pixel 111, a second sub-pixel 112, and a black matrix 113. The first sub-pixel 111 is disposed in the first sub-pixel region DR1, and the second sub-pixel 112 is disposed in the second sub-pixel region DR2. The black matrix 113 is at least partially disposed between the first sub-pixel 111 and the second sub-pixel 112. The lens unit 120 is disposed correspondingly to the display unit 110. In other words, the first sub-pixel region DR1 and the second sub-pixel region DR2 may include an opening region (not shown) and a light-shielding region (not shown), the first sub-pixel 111 and the second sub-pixel 112 are respectively disposed in the opening region of the first sub-pixel region DR1 and in the opening region of the second sub-pixel region DR2, and the black matrix 113 is disposed in the light-shielding region correspondingly, but not limited thereto.

It is worth noting that only one lens unit 120 is disposed correspondingly to one display unit 110 as shown in FIG. 3, but the present invention is not limited to this. In other preferred embodiments of the present invention, a plurality of lens units 120 and a plurality of display units 110 may also be disposed in the stereoscopic display device 100. Each of the lens units 120 may be disposed correspondingly to one of the display units 110. In addition, the first sub-pixel 111 and the second sub-pixel 112 may be used to generate left-eye display images and right-eye display images, and the left-eye display images and right-eye display images may be respectively guided toward a left eye and a right eye of a viewer through the lens units 120 so as to generate the stereoscopic display effect, but not limited thereto. For example, the first sub-pixel 111 and the second sub-pixel 112 may also be used to generate identical display images, and the stereoscopic display device 100 may provide a normal two-dimensional display effect accordingly. The display unit 110 in this embodiment may include a liquid crystal display unit, an organic light emitting diode display unit, an electro-wetting display unit, an e-ink display unit, a plasma display unit, a field emitting display unit, or other appropriate display units.

In this embodiment, the lens unit 120 includes a first sub-lens 121 and a second sub-lens 122. The first sub-lens 121 is disposed in the first sub-pixel region DR1. The first sub-lens 121 has a first lens center axis 121C. The second sub-lens 122 is disposed in the second sub-pixel region DR2. The second sub-lens 122 has a second lens center axis 122C. The first lens center axis 121C and the second lens center axis 122C deviate from the display center axis 110C along the first direction X. Because the display unit 110 in this embodiment is disposed correspondingly to the first sub-lens 121 and the second sub-lens 122 having different lens center axes, display images generated by the first sub-pixel 111 and the second sub-pixel 112 may be guided to the left eye and the right eye of the viewer more effectively, and the blind spot issue in some specific viewing angles may be accordingly improved.

More specifically, as shown in FIG. 3, the display unit 110 in this embodiment has a display unit width P along the first direction X, the first sub-pixel 111 has a first width W1 along the first direction X, the second sub-pixel 112 has a second width W2 along the first direction X, and the black matrix 113 between the first sub-pixel 111 and the second sub-pixel 112 has a third width W3. The third width W3 is substantially equal to the first width W1 and the second width W2, and display unit width P is substantially four times as wide as the third width W3. Additionally, the first lens center axis 121C deviates positively from the display center axis 110C of the display unit 110 along the first direction X by one length, the second lens center axis 122C deviates negatively from the display center axis 110C of the display unit 110 along the first direction X by the same length, and the length mentioned above is substantially one eighth of the display unit width P. It is worth noting that the length mentioned above is substantially one eighth of the display unit width P with a variation of 3% plus or minus according to reasonable process variations, but not limited thereto. In other words, the first lens center axis 121C is disposed in the first sub-pixel region DR1, and the second lens center axis 122C is disposed in the second sub-pixel region DR2. A distance D1 between the first lens center axis 121C and the display center axis 110C of the display unit 110 along the first direction X is substantially one eighth of the display unit width P, and a distance D2 between the second lens center axis 122C and the display center axis 110C of the display unit 110 along the first direction X is substantially one eighth of the display unit width P. In addition, the first lens center axis 121C is disposed correspondingly to an interface between the first sub-pixel 111 and the black matrix 113 between the first sub-pixel 111 and the second sub-pixel 112 along the second direction Y, and the second lens center axis 122C is disposed correspondingly to an interface between the second sub-pixel 112 and the black matrix 113 between the first sub-pixel 111 and the second sub-pixel 112 along the second direction Y. It is worth noting that the first sub-lens 121 and the second sub-lens 122 may preferably have a focal length F respectively, and focal points of the first sub-lens 121 and the second sub-lens 122 are preferably located on the display unit 110, but not limited thereto. The stereoscopic display device 100 in this embodiment may present a stereoscopic display effect as shown in FIG. 4 according to the arrangement design of the display unit 110 and the lens unit 120 described above.

As shown in FIG. 3 and FIG. 4, the X-axis in FIG. 4 represents viewing angle, and the Y-axis in FIG. 4 represents luminance. Regions L1 and regions L2 represent luminance conditions of left-eye display images in different viewing angles. Regions R1 and regions R2 represent luminance conditions of right-eye display images in different viewing angles. The regions L1 are formed by the first sub-pixel 111 through the first sub-lens 121, the regions L2 are formed by the first sub-pixel 111 through the second sub-lens 122, the regions R1 are formed by the second sub-pixel 112 through the first sub-lens 121, and the regions R2 are formed by the second sub-pixel 112 through the second sub-lens 122. As shown in FIG. 3 and FIG. 4, the first sub-lens 121 is disposed correspondingly to the first sub-pixel 111, and the second sub-lens 122 is disposed correspondingly to the second sub-pixel 112. The first sub-lens 121 and the second sub-lens 122 have different lens center axes. The widths of the first sub-pixel 111, the second sub-pixel 112, and the black matrix 113 may be further modified for effectively avoiding the blind spot issue in some specific viewing angles, and the stereoscopic display effect may be improved accordingly. It is worth noting that the first sub-lens 121 and the second sub-lens 122 may preferably include a curved lens, a non-curved lens or lenses in other appropriate shapes. The first lens center axis 121C and the second lens center axis 122C in this embodiment may preferably extend along a third direction Z perpendicular to both the first direction X and the second direction Y, but not limited thereto. In other words, the first sub-lens 121 and the second sub-lens 122 may preferably include a curved lens pillar, a non-curved lens pillar or lens pillars in other appropriate shapes. When the first sub-lens 121 and the second sub-lens 122 are curved lens pillars with a refractive index n and a focal length F, a following equation (I) may be used to calculate a radius of curvature R of the first sub-lens 121 and the second sub-lens 122, but not limited thereto.

R={(n−1)/n}F (I)

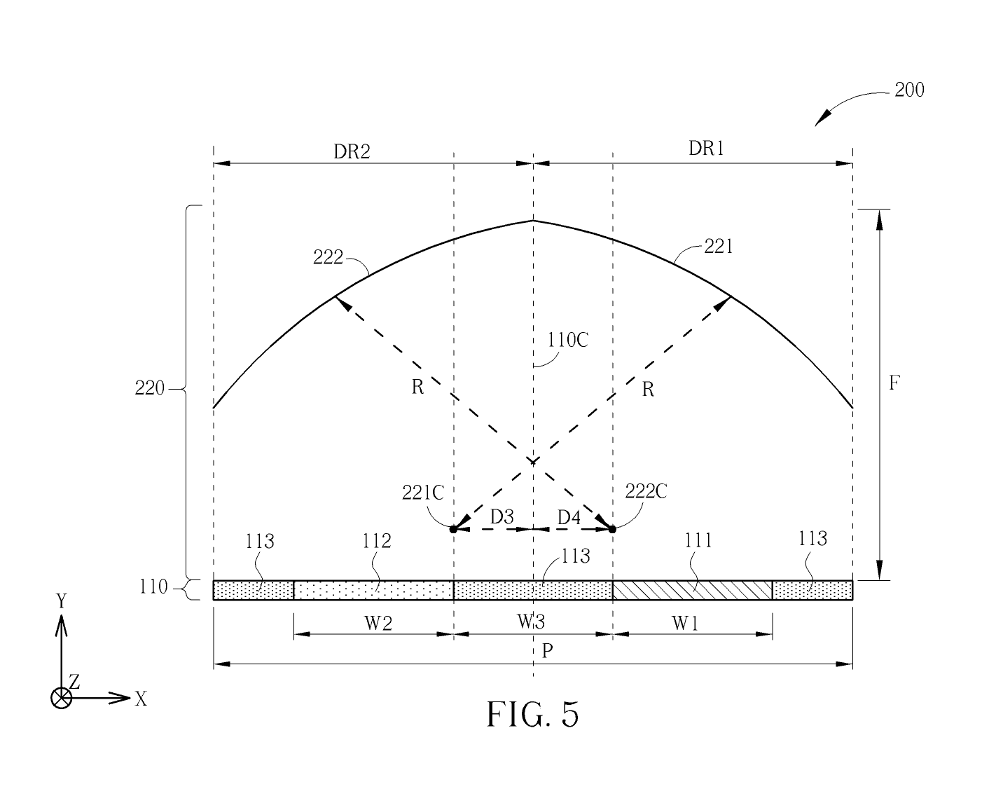

As shown in FIG. 5, a stereoscopic display device 200 is provided in this embodiment. The stereoscopic display device 200 has a first sub-pixel region DR1 and a second sub-pixel region DR2 aligned along the first direction X. The stereoscopic display device 200 includes a display unit 110 and a lens unit 220. The detail characteristics of the display unit 110 in this embodiment have been detailed above and will not be redundantly described. The lens unit 220 is disposed correspondingly to the display unit 110. The lens unit 220 includes a first sub-lens 221 and a second sub-lens 222. The first sub-lens 221 is disposed in the first sub-pixel region DR1. The first sub-lens 221 has a first lens center axis 221C. The second sub-lens 222 is disposed in the second sub-pixel region DR2. The second sub-lens 222 has a second lens center axis 222C. The first lens center axis 221C and the second lens center axis 222C deviate from the display center axis 110C of the display unit 110 along the first direction X.

More specifically, the first lens center axis 221C deviates negatively from the display center axis 110C of the display unit 110 along the first direction X by one length, the second lens center axis 222C deviates positively from the display center axis 110C along the first direction X by the same length, and the length mentioned above is substantially one eighth of the display unit width P. In addition, the length mentioned above is substantially one eighth of the display unit width P with a variation of 3% plus or minus according to reasonable process variations, but not limited thereto. In other words, the first lens center axis 221C is disposed in the second sub-pixel region DR2, and the second lens center axis 222C is disposed in the first sub-pixel region DR1. A distance D3 between the first lens center axis 221C and the display center axis 110C of the display unit 110 along the first direction X is substantially one eighth of the display unit width P, and a distance D4 between the second lens center axis 222C and the display center axis 110C of the display unit 110 along the first direction X is substantially one eighth of the display unit width P. In addition, the first lens center axis 221C is disposed correspondingly to an interface between the second sub-pixel 112 and the black matrix 113 between the first sub-pixel 111 and the second sub-pixel 112 along the second direction Y, and the second lens center axis 222C is disposed correspondingly to an interface between the first sub-pixel 111 and the black matrix 113 between the first sub-pixel 111 and the second sub-pixel 112 along the second direction Y. Apart from the positions of the lens center axes in this embodiment, the other optical properties of the first sub-lens 221 and the second sub-lens 222, and the stereoscopic display principle of the first sub-lens 221 and the second sub-lens 222 arranged with the display unit 110 are similar to those of the embodiment detailed above and will not be redundantly described.

To summarize the above descriptions, in the stereoscopic display device of the present invention, two sub-lenses having different lens center axes deviating from the display center axis of the display unit toward different directions are disposed correspondingly to two sub-pixels generating the left-eye image and the right-eye image respectively, and the deviating conditions of the lens center axes are modified with the width of the black matrix so as to improve the stereoscopic display blind spot issue in some specific viewing angles caused by black matrix. The stereoscopic display quality may be enhanced accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stereoscopic display device, having a first sub-pixel region and a second sub-pixel region aligned along a first direction, the stereoscopic display device comprising:
a display unit, having a display center axis corresponding to an interface between the first sub-pixel region and the second sub-pixel region, the display unit comprising:
a first sub-pixel, disposed in the first sub-pixel region;
a second sub-pixel, disposed in the second sub-pixel region; and
a black matrix, at least partially disposed between the first sub-pixel and the second sub-pixel; and
a lens unit, disposed correspondingly to the display unit, the lens unit comprising:
a first sub-lens, disposed in the first sub-pixel region and having a first lens center axis; and
a second sub-lens, disposed in the second sub-pixel region and having a second lens center axis, wherein the first lens center axis and the second lens center axis deviate from the display center axis along the first direction.

2. The stereoscopic display device of claim 1, wherein the display unit has a display unit width along the first direction, the first sub-pixel has a first width along the first direction, the second sub-pixel has a second width along the first direction, the black matrix between the first sub-pixel and the second sub-pixel has a third width, the third width is equal to the first width and the second width, and display unit width is four times as wide as the third width.

3. The stereoscopic display device of claim 2, wherein the first lens center axis deviates positively from the display center axis along the first direction by one length, the second lens center axis deviates negatively from the display center axis along the first direction by the length, and the length is one eighth of the display unit width.

4. The stereoscopic display device of claim 2, wherein the first lens center axis is disposed in the first sub-pixel region, the second lens center axis is disposed in the second sub-pixel region, a distance between the first lens center axis and the display center axis along the first direction is one eighth of the display unit width, and a distance between the second lens center axis and the display center axis along the first direction is one eighth of the display unit width.

5. The stereoscopic display device of claim 2, wherein the first lens center axis is disposed correspondingly to an interface between the first sub-pixel and the black matrix along a second direction perpendicular to the display unit, and the second lens center axis is disposed correspondingly to an interface between the second sub-pixel and the black matrix along the second direction.

6. The stereoscopic display device of claim 2, wherein the second lens center axis deviates positively from the display center axis along the first direction by one length, the first lens center axis deviates negatively from the display center axis along the first direction by the length, and the length is one eighth of the display unit width.

7. The stereoscopic display device of claim 2, wherein the first lens center axis is disposed in the second sub-pixel region, the second lens center axis is disposed in the first sub-pixel region, a distance between the first lens center axis and the display center axis along the first direction is one eighth of the display unit width, and a distance between the second lens center axis and the display center axis along the first direction is one eighth of the display unit width.

8. The stereoscopic display device of claim 2, wherein the first lens center axis is disposed correspondingly to an interface between the second sub-pixel and the black matrix along a second direction perpendicular to the display unit, and the second lens center axis is disposed correspondingly to an interface between the first sub-pixel and the black matrix along the second direction.

9. The stereoscopic display device of claim 1, wherein the first sub-lens includes a curved lens or a non-curved lens, and the second sub-lens includes a curved lens or a non-curved lens.

10. The stereoscopic display device of claim 1, wherein focal points of the first sub-lens and the second sub-lens are located on the display unit.
